(19) United States
(12) Patent Application Publication
(10) Pub. No.: US 2019/0022805 A1
(43) Pub. Date: Jan. 24, 2019

(54) Method of Designing and Producing High Performance Carbon Ceramic Pistons

(71) Applicant: Bryan Gill, Rancho Palos Verdes, CA (US)

(72) Inventor: Bryan Gill, Rancho Palos Verdes, CA (US)

(21) Appl. No.: 16/042,350

(22) Filed: Jul. 23, 2018

Related U.S. Application Data
(60) Provisional application No. 62/541,535, filed on Aug. 4, 2017.
(60) Provisional application No. 62/535,821, filed on Jul. 21, 2017.

(51) Int. Cl. B23P 15/10; F02F 3/00

(52) U.S. Cl. CPC B23P 15/10; F02F 3/0084; F02F 2200/06; F05C 2203/0808; F02F 3/0023

(57) ABSTRACT

A method is provided of designing and producing a piston using chopped carbon ceramic pre-impregnated composite material, wherein the method allows piston designers to produce a fiber/composite preform, then machine any of several different piston designs, diameters, with different ring and chamber designs or dimensions and dimensional offsets. The piston preform is shaped in a basic form, and then machined into a piston that fits a specific engine. After the specific machining is performed, the pin bosses are bored and fitted with bronze inserts; ring lands are cut, skirts are shaped, finish machining is performed on all surfaces. Pistons are preferably then plated to seal carbon ceramic based materials, and the skirts as well as regions that engage in part-to-part moving contact, are plasma coated with anti-friction material(s). The skirts may be made as a separate skirt preform which is fitted, machined or cut to fit the specific piston. The overall process is adapted to skirt regions of differing size, length or offset that are assembled into a unitary structure of improved strength/weight characteristics. The method is useful for making high-performance engine modification parts having high strength and reduced inertial mass

### TECHNICAL FIELD

The present invention relates to automotive piston manufacturing and methods of designing and producing high performance pistons.

### SUMMARY OF THE INVENTION

More specifically, the present invention pertains to a new method of designing and producing a composite piston using compression molded, chopped composite material that is machinable after being formed, along with a design process that allows several different designs to be machined from a shaped mold of composite material.

Automotive pistons are well known structures that support the combustion of internal combustion engines. High performance pistons are designed to have light weight and high strength, allowing the pistons to specifically designed to reduce reciprocating mass (allowing faster response) and yet be sufficiently durable for competition or rigorous use, while maintaining ring stability through the cycle. High performance and exotic engines are not the only engines in which may benefit from this technology. Pistons can, for example, be replaced for increased performance or to achieve better fuel economy. The present invention is directed to a new method of manufacturing and designing high performance pistons, which aims to increase performance thereof while maintaining a high degree of manufacturing economy.

The present invention relates to a new method of designing and producing composite pistons, and carbon ceramic piston designs that do not require specific molds or different sizes, those with different can be formed into a shape using a compression molding technique. The resulting material is non-directional and conforms to the shape of the mold, wherein the chopped fibers are supported within a matrix in random directions to produce an overall quasi-isotropic material system. Using this material, the piston design process benefits and can utilize the fact that this material system is machinable after being formed. Further provided is an efficient design method that utilizes the chopped composite material system to create a piston blank that is adaptable to different diameters while minimizing lost materials during the machining process. Once the piston design is machined, the piston can then be plated, bushed in the pin areas and anti-friction plated or coated in regions that engage in moving contact. For example, anti-friction properties may be enhanced on smoothly machined surfaces by treatments which form or convert to nitride or carbide hard ceramic surface functionality.

The present new design and manufacturing method of composite pistons using chopped carbon ceramic material, reduces material waste, reduces engineering design expense for each piston design, and reduces the cost of providing composite pistons to consumers. Various molds are used to accommodate a plurality of piston designs, sizes, diameters, and shapes, whereby the resulting piston blank from the single mold process is machined to a specific size and shape for the desired piston. For example a fiber/composite piston blank may have a body that can be machined down to a specific diameter, and may possess bosses that may be through-bored and bushed to receive a connecting rod wrist pin at one or more different offsets from the piston top, or have a piston upper surface that can be machined to accommodate valve faces moving at oblique angles near the top-of-stroke position. The piston blank may also include a separately molded piston skirt assembly, that is supported by or fastened to the body of the piston, thus adapting the piston to engines of different bore, different stroke, and or internal clearances. The resulting assembled or machined piston blank may be then connected to a connecting rod to produce a high performance piston at a reduced cost and weight compared to traditional methods of aluminum pistons in the market.

The present invention substantially differs in design elements and method steps from the prior art by forming a piston blank or preform, that rather than being a roughly final form, is machined, cut or altered to matched one of a number of potential patterns, and then finish-machined. The overall design and production method fills a need in the art for an improvement of the existing energy-intensive and engineering-intensive aluminum piston designs and manufacturing methods. In this regards the instant invention goes against prior art practice of producing a single rough form, and relies upon making a multi-use piston blank that substantially overcomes the costly stages of the prior art, and fulfills these needs.

In the view of the foregoing disadvantages inherent in the known types of aluminum pistons and design and manufacturing methods present in the art, the present invention provides a new design and manufacturing method wherein the same can be utilized for producing a composite piston that reduces cost and wasted material to produce a lightweight, high performance piston for competition or road use.

The invention provides a new method of designing and manufacturing composite pistons, wherein the method includes a process of forming chopped carbon ceramic material into a piston blank that is machinable to the end design of the given piston.

Another object of the present invention is to provide a design method for creating a composite piston in which one mold can be utilized to create a piston blank that accommodates a plurality of different piston end-designs, whereby the final design is machined from the singly designed blank.

Another object of the present invention is to provide design method of composite pistons that aims increase the efficiency to the end consumer, while still retaining the primary advantages associated with composite pistons (light weight, high stiffness, high strength, greater fatigue life, etc.).

Other objects, features and advantages of the present invention will become apparent from the following detailed description taken in conjunction with the accompanying drawings.

### BRIEF DESCRIPTION OF THE DRAWINGS

FIG. 1 is a perspective view of a piston 1 including a generally cylindrical piston body with ring lands or grooves;

FIG. 2 is an exploded perspective view of the piston showing opposed skirt portions fastened to the piston body.

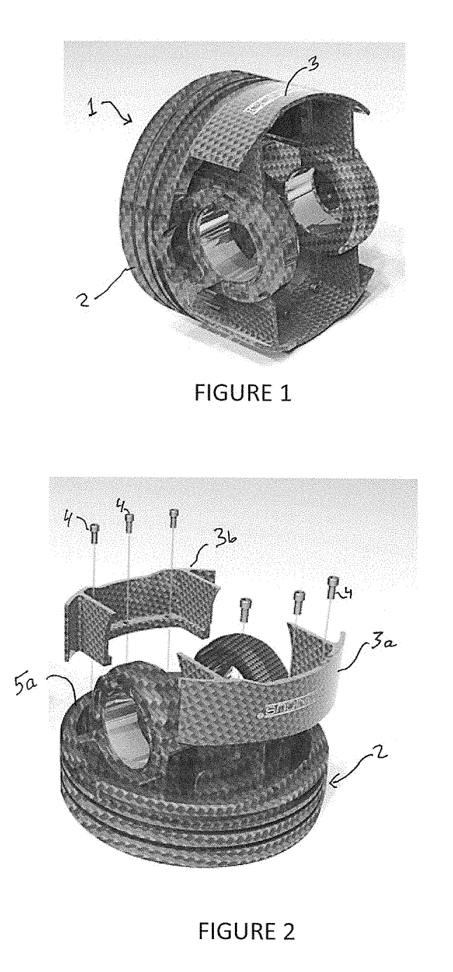

### DETAILED DESCRIPTION

Reference is made herein to the attached drawings. Like reference numerals are used throughout the drawings to depict like or similar elements of the present method. For the purposes of presenting a brief and clear description of the present invention, the preferred embodiment will be discussed as used for creating a composite piston blank section using chopped carbon ceramic material and a design process that minimizes waste and costs. The figures are intended for representative purposes only and should not be considered to be limiting in any respect.

The present invention is a new design method and method of manufacturing for pistons using composite material, wherein the production of the piston involves a forming process and the design method allows for multiple different piston designs to be incorporated into a single manufacturing process. The design method reduces material waste and costs of the piston for the end consumer, while maintaining the benefits offered by composite pistons. Specifically, chopped carbon ceramic reinforced plastic is used to create the piston, wherein the chopped fiber is placed into a mold, compression molded into a formed shape, and then machined into a final piston design. The use of chopped fibers and a forming process allows designers and fabricators to machine the final design from a larger piston blank, which allows one piston blank to be utilized for multiple piston designs without individually engineering each piston and creating a specific mold for each piston design. This eliminates the traditional aluminum forging process, which is labor- and energy-intensive, and design- or engineering-intensive, and requires a specific mandrel or mold for each piston design.

The present invention by contrast contemplates creating a composite piston blank of carbon ceramic, but rather than forging aluminum, the present invention method utilizes a chopped fiber compression molding process and a design process similar to metallic piston fabrication but with improved efficiency and with greater RPM optimization. Chopped carbon ceramic is more expensive than conventional metallic materials, but now a shaped piston blank is created from the combination of several different piston designs, which can then be machined down to the exact piston design chosen by the end user. Piston designs are overlaid onto one another in a design space to establish the shape of the piston blank to be created from the chopped carbon ceramic material in a mold. The process can accommodate pistons of different diameter and design, wherein the final product is connected to a rod assembly.

Once released from the mold, the carbon ceramic piston blank is machined into a final design. A CNC milling machine or similar device is utilized to machine the larger piston blank into the final piston design. By way of example, the top face of the piston may be milled to a shape that accommodates valves that project into the combustion chamber, and the major cylindrical body may be milled or turned to form grooves for holding the upper compression or oil scraper rings, as well as forming the precise diameter or taper or eccentricity desired for proper clearance and running in the engine bore into which the piston will fit.

As further shown in the Figures, the composite piston body 1 may be assembled from two portions, which form the major cylindrical piston body 2 and the piston skirt or skirt assembly 3. As shown in FIG. 2, the skirt assembly may be formed with opposed half-skirts 3a, 3b, which fasten with pins or screw/bolts 4 to lands 5a machined or otherwise formed on the lower outer edges of the piston body. The skirt portions may provide, or be cut to provide, the desired skirt length and properly positioned bearing surface to avoid piston rocking and wear.

In accordance with another or further aspect of the invention, the carbon fiber or matrix piston body and/or skirt are sealed against fluid uptake by impregnation with a suitable sodium silicate solution, a process known for. This process of impregnation is used to arrest fluid uptake by or in carbon matrix composite based materials.

Ever since metal casting was first discovered, porosity, an area of sponge-like internal structure in an otherwise sound metal part, has been a problem. Porosity may be caused by internal shrinkage, gas cavitation, oxide films, inclusions and combinations thereof. It can be found in virtually any type of metal casting or part, and is, a problem in castings made from aluminum, zinc, bronze, iron, magnesium, and other alloys. Porosity is always present in powdered or sintered metal parts because of their structural nature. Various methods have been used to attempt filling porous openings in parts designed to contain liquids or gases under pressure. One of the first materials used for impregnation was “water-glass” or sodium silicate. In addition to sodium silicate, tung oil, linseed oil, pitch gum and many other materials were used with little success. Shortly after World War II, the development of thermosetting plastics, to be used as impregnate, became an effective and economical means of sealing porosity within the walls of metal castings, especially when used in conjunction with vacuum pressure impregnation techniques. In the realm of advanced composites and an ever-changing world with more demands placed upon the scientific community for greater efficiency, there's a need to produce component and products lighter and more efficient. With the advent of carbon based materials, the problem of porosity has persisted, and thus the need for sealing composite based materials. We have successfully addressed this problem in carbon-based matrix and composites materials at an early stage of manufacture by impregnation with sodium silicates solutions to address the fluid uptake issues.

Impregnation in metal castings parts refer to the sealing of leaks resulting from porosity. The impregnating material, as a liquid, is introduced into the voids or porosity within the wall of the part usually using vacuum and pressure. The material is then solidified, filling the porous openings and making the part pressure tight. Impregnation of powdered metal parts not only seals parts for pressure applications, but also improves plating or finishing, since bleed out or spotting due to entrapment of plating solutions in the pores is eliminated. Extended tool life is another benefit when machining powdered metal parts. Because of the proven effectiveness and economies of impregnation, many engineers specify its use for all types of metal parts that must contain liquids or gases under pressure. Incorporation of the impregnation processes directly into production schedules further ensures quality, rather than to be used strictly as a salvage operation.

There are two general classifications of porosity found in metal parts: macro-porosity in the form of large flaws in the part which may be visible to the naked eye; and micro-porosity in the form of very small, almost invisible voids. In various metal and car on based matrix composites and some powdered metal parts, the structure of the metal results in a condition similar to macro-porosity in castings having low density, and micro-porosity in high density castings. Porosity can be found as continuous, blind, or totally enclosed. Continuous porosity stretches completely through the wall thickness of a metal part causing a leakage path. Blind porosity is connected only to one side of the part wall. Totally enclosed porosity is totally isolated within the wall thickness of a part. When metal castings are machined, both blind and totally enclosed porosity are often “opened up” becoming continuous porosity and causing leaks. Modern impregnation technology permanently seals porosity leaks caused by either micro- or macro-porosity, in carbon based matrix composites and metal.

There are four common methods of impregnation consisting of dry vacuum-pressure, internal pressure, wet vacuum-pressure and wet vacuum only.

The dry vacuum-pressure is accomplished as follows:
1. Within an autoclave a vacuum is drawn, the air in the pores is evacuated without an impregnating liquid present to impede the evacuation to a level of 15 to 35 torr.
2. The liquid Sodium Silicate Solution is introduced while the parts are still under vacuum.
3. A pressure cycle, up to 80-90 psi of shop air pressure (or up to six atmospheres) forces the Sodium Silicate Solution deep into the porous cavities of the part for more positive sealing.

After the impregnation cycle the part is removed from the autoclave, the surface is then rinsed in plain water, leaving no evidence or film of the impregnating material on the part surface. Machined surfaces or tolerances are not affected. The liquid material in the pores is cured by the application of heat.

Internal impregnation may accomplished by placing the Sodium Silicate Solution inside the casting and applying hydraulic pressure to the interior space. This procedure is utilized in extremely large castings, forcing the liquid Sodium Silicate Solution through the leak paths in the casting wall.

Wet vacuum-pressure and wet vacuum only differ in the application of pressure. They both introduce parts into a sodium silicate solution bath and evacuate the air above the bath and subsequently from the porosity of the parts through the surrounding liquid sodium silicate solution. Pressure, either atmospheric or shop air is then applied to aid in penetration of sodium silicate solution.

Any of the foregoing sealing methods may be applied to the piston blanks before machine finishing or anti-friction treatment.

It is submitted that the instant invention has been shown and described in what is the most practical and preferred method steps. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function, steps, and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of designing and producing fully plated composite pistons using a carbon based composite material, comprising the steps of:
Choosing one or a plurality of piston designs;
Overlaying said piston designs to determine a single piston blank design;
Creating a reverse mold of said piston blank design;
Compression molding a piston blank using said reverse mold; and
Machining said piston blank into one of said piston designs.

2. The method of claim 1, wherein said choosing said piston designs further comprises the steps of:
Determining diameter, combustion surface, and ring package if necessary of said piston designs prior to overlaying said piston designs.

3. The method of claim 1, wherein compression molding said piston blank further comprising the steps of:
Heating composite material;
Communicating said composite material after heating into said mold;
Compressing said material in said mold using a press;
Removing said material after cooling.

4. The method of claim 1 further comprising the steps of:
a. placing the piston blank or parts thereof in an autoclave or an evacuated chamber such that air or gas in pores is evacuated without an impregnating liquid present to impede the evacuation preferably at a pressure level of 15 to 35 torr; and
b. introducing a liquid sodium silicate or other sealant solution while the parts are still under vacuum and optionally
c. applying a pressure cycle up to 80-90 psi of shop air pressure (or up to six atmospheres) to drive the sealant solution deep into the porous cavities of the part for more positive sealing.

5. The method of claim 4, wherein after the impregnation cycle the part is removed from the autoclave, the surface is then rinsed in plain water, leaving no evidence or film of the impregnating material on the part surface, and applying heat to cure any liquid material in the pores.

6. A method of sealing large castings by internal impregnation, by placing a sealant solution inside the casting and applying hydraulic pressure to force the sealant solution through leak paths in the casting wall.
